(19) United States
(12) Patent Application Publication
(10) Pub. No.: US 2018/0009353 A1
(43) Pub. Date: Jan. 11, 2018

(54) VEHICLE SEAT

(71) Applicant: TACHI-S CO., LTD., Akishima-shi, Tokyo (JP)

(72) Inventors: Takashi YOKOYAMA, Akishima-shi, Tokyo (JP); Naoyuki MAKITA, Akishima-shi, Tokyo (JP)

(21) Appl. No.: 15/544,306

(22) PCT Filed: Jan. 12, 2016
(86) PCT No.: PCT/JP2016/050592

§ 371 Date: Jul. 18, 2017

(30) Foreign Application Priority Data
Feb. 9, 2015 (JP) 2015-023196

(51) Int. Cl. B60N 2/68; B60N 2/20; B60N 2/64; B60R 21/207

(52) U.S. Cl. CPC B60N 2/68; B60R 21/207; B60N 2/20; B60N 2/64

(57) ABSTRACT

A configuration is adopted such that the shape of a peripheral wall portion of a shell-shaped seat back skeleton can be freely set without being restricted by the presence of brackets, the incidence of warping of the seat back skeleton when a vehicle is involved in a rear-end or head-on collision is reduced, and the seat back skeleton does not lose strength even when brackets are affixed to the seat back skeleton. A seat cushion skeleton 8 and the seat back skeleton 9 are coupled by coupling means 19a, 19b, and the seat back skeleton 9 has a main body 14 facing the back of a seated passenger, and a peripheral wall part 15 provided to the peripheral edge of the main body 14. The main body 14 and the peripheral edge part 15 are formed into an integrated shell shape using a synthetic resin. The coupling means 19a, 19b have first brackets 21a, 21b that are joined to the seat back skeleton 9, the first brackets 21a, 21b being affixed by bonding to the main body 14 of the seat back skeleton 9.

### TECHNICAL FIELD

The present invention relates to a vehicle seat having a shell-shaped seat back skeleton.

### BACKGROUND ART

“Shell-shaped” refers to a shape formed by a single sheet-like member; i.e., a three-dimensional shape formed so as to correspond to the contours of an object such as a person (e.g., the contours of a person's back).

Conventionally, vehicle seats having a shell member that is separate from a seat back skeleton (i.e., seat back frame) are disclosed in Patent Document 1 (JP-A 2013-075558) and Patent Document 2 (JP-A 2014-201266). In these conventional vehicle seats, the seat back skeletons are not shell-shaped, but are formed in a frame shape, i.e., a skeletal structure, and a shell member is added to the seat back skeleton.

Conventionally, an integrally formed vehicle seat in which the seat back shell and the seat cushion shell are formed as an integrated whole is disclosed in Patent Document 3 (JP-A 63-232046). In this conventional vehicle seat, the seat back shell is secured to the seat cushion shell in such a way as to be incapable of inclining with respect to the seat cushion shell.

Conventionally, according to Patent Document 4 (JP-A 2012-192758), disclosed is a frame structure in which a shell that is separate from a seat frame is connected to the seat frame. The seat frame is formed by coupling the seat cushion skeleton and the seat back skeleton. In the shell, the seat cushion portion and the seat back portion are integrated. Even in this conventional structure, the frame and the shell are separate bodies.

Conventionally, according to Patent Document 5 (JP-A 2009-142341), disclosed is a seat back skeleton to be the skeleton of a seat back that is formed into a shell shape using a synthetic resin. Using this shell-shaped seat back skeleton allows a seat back of the desired shape; e.g., a bucket seat, to be produced. A bucket seat is a seat in which the height of the left and right edges is increased in comparison to a typical seat, and the rear and shoulders of a person settle deeply into the seat, whereby the body is more secure.

Usually, the seat back skeleton is connected to the seat cushion skeleton. In many cases, the seat back skeleton is connected to the seat cushion skeleton so as to be able to move at an incline with respect thereto. In the skeleton structure in which the shell-type seat back skeleton disclosed in Patent Document 5 is used, bolts and nuts are used to affix brackets to the peripheral wall portion of the shell-shaped seat back skeleton, and the seat back skeleton is connected to the seat cushion skeleton via the brackets.

### CITATION LIST

### Patent Literature

Patent Document 1: JP-A 2013-075558

Patent Document 2: JP-A 2014-201266

Patent Document 3: JP-A 63-232046

Patent Document 4: JP-A 2012-192758

Patent Document 5: JP-A 2009-142341

### SUMMARY OF INVENTION

### Technical Problem

Since brackets are affixed to the peripheral wall portion of the shell-shaped seat back skeleton in Patent Document 5 mentioned above, the shape of the peripheral wall portion of the shell-shaped seat back skeleton is inevitably restricted to a shape allowing brackets to be affixed thereto, which has presented a problem in that the shape of the peripheral wall portion cannot be freely designed. For example, air bag devices for ensuring the safety of seated passengers during a collision are sometimes installed in the peripheral wall portion of the shell-shaped seat back skeleton. In that case, a problem may be presented in that the functionality of such air bag devices cannot be fully realized because the shape of the peripheral wall portion is adapted to the conditions for affixing brackets.

A further problem may be presented in that when brackets are affixed to the peripheral wall portion of the shell-shaped seat back skeleton, and another vehicle has a rear-end or head-on collision with the vehicle provided with the seat back skeleton, the seat back skeleton will be warped by the force acting on the affixed portion at the time of the collision.

In Patent Document 5 mentioned above, the brackets are joined to the shell-shaped seat back skeleton by bolts and nuts, and therefore holes must be provided in the seat back skeleton for the bolts to pass through. There is a problem in that when holes are thus provided in the shell-shaped seat back skeleton, the strength of the seat back skeleton at the portion that has the holes is greatly reduced.

The present invention was contrived in view of the above-mentioned problems in the conventional devices, it being an object of the present invention to make it possible for the shape of the peripheral wall portion of the shell-shaped seat back skeleton to be set freely without being restricted by the presence of brackets, to reduce the incidence of warping in the seat back skeleton when the vehicle is involved in a rear-end or head-on collision, and to adopt a configuration for preventing the seat back skeleton from losing strength even when brackets are affixed to the seat back skeleton.

### Solution to Problem

A vehicle seat according to the present invention comprises a seat cushion upon which the buttocks of a seated passenger rest, and

a seat back for receiving the back of the seated passenger;

the seat cushion comprising a seat cushion skeleton, a pad mounted on the seat cushion skeleton, and a surface skin covering the pad;

the seat back comprising a seat back skeleton, a pad mounted on the seat back skeleton, and a surface skin covering the pad;

the seat cushion skeleton and the seat back skeleton being coupled by coupling means;

the seat back skeleton comprising a main body facing the back of the seated passenger, and a peripheral wall part provided to the peripheral edge of the main body, and

the main body and the peripheral wall part being formed into an integrated shell shape by a synthetic resin;

the coupling means comprising a first bracket joined to the seat back skeleton; and the first brackets being affixed by bonding to the main body of the seat back skeleton.

According to the vehicle seat of the present invention, since the first bracket is affixed to the main body of the seat back skeleton and not the peripheral wall part, the shape of the peripheral wall portion of the seat back skeleton can be set freely without being restricted by the presence of the first brackets.

According to the vehicle seat of the present invention, furthermore, since the first brackets are affixed to the main body of the seat back skeleton and not the peripheral wall part, the incidence of warping in the seat back skeleton when the vehicle is involved in a rear-end or head-on collision can be reduced.

Furthermore, according to the vehicle seat of the present invention, since the first bracket is secured by bonding to the seat back skeleton, there is no need to provide hole for bolt in the seat back skeleton as in a case where fastening is accomplished with bolts and nuts. When holes are formed in the seat back skeleton the strength of the seat back skeleton is dramatically reduced, but in the present invention there are no differently shaped portions such as holes in the seat back skeleton; therefore, the strength of the seat back skeleton can be kept high.

In another aspect of the vehicle seat according to the present invention, the coupling means has an inclined movement mechanism for supporting the seat back skeleton so as to be able to move at an incline with respect to the seat cushion skeleton, and second brackets that work in cooperation with the first brackets to hold the inclined movement mechanism therebetween, the second brackets being connected to the seat cushion skeleton and thereby coupling the seat cushion skeleton and the seat back skeleton together.

In this aspect, the inclined movement mechanism can be configured using, for example, a reclining mechanism. According to this aspect, the angle of incline of the seat back with respect to the seat cushion can be adjusted by the working of the inclined movement mechanism.

In another aspect of the vehicle seat according to the present invention, the first bracket has a portion for forming a gap with respect to the peripheral wall part of the seat back skeleton, and an air bag device is stored in the gap.

According to this aspect, the safety of the seated passenger can be protected during a vehicle collision by the working of the air bag device. Also, in the present invention the first brackets are affixed to the main body and not the peripheral wall part of the seat back skeleton, and therefore the bonding strength of the first brackets with respect to the seat back skeleton does not change even when the height of the peripheral wall part is set to be low. If the height of the peripheral wall part of the seat back skeleton is low, the trajectory of the air bag expanding out from the air bag device is wide, and therefore the air bag can be accurately deployed when needed. In other words, the behavior of the air bag can be stabilized.

In yet another aspect of the vehicle seat according to the present invention, the seat back skeleton is formed from carbon fiber reinforced plastic (CFRP). When CFRP is used, the seat back skeleton can be formed thinner, lighter, and stronger. Since no holes are formed in the seat back skeleton for a bolt in the present invention, the strength of the CFRP is not reduced.

### Advantageous Effects of Invention

According to the vehicle seat of the present invention, since the first brackets are affixed to the main body and not the peripheral wall part of the seat back skeleton, the shape of the peripheral wall portion of the seat back skeleton can be set freely without being restricted by the presence of the first brackets.

According to the vehicle seat of the present invention, furthermore, since the first brackets are affixed to the main body and not the peripheral wall part of the seat back skeleton, the incidence of warping in the seat back skeleton when the vehicle is involved in a rear-end or head-on collision can be reduced.

Furthermore, according to the vehicle seat of the present invention, since the first brackets are secured to the seat back skeleton by bonding, there is no need to provide holes for bolts in the seat back skeleton as in a case where fastening is done by bolts and nuts. When holes are opened in the seat back skeleton, the strength of the seat back skeleton is dramatically reduced, but in the present invention there are no differently shaped portions such as holes in the seat back skeleton, and therefore the strength of the seat back skeleton can be kept high.

### BRIEF DESCRIPTION OF DRAWINGS

FIG. 1 is a perspective view showing an embodiment of a vehicle seat according to the present invention as viewed from the front;

FIG. 2 is a perspective view showing the vehicle seat of FIG. 1 as seen from the rear;

FIG. 3 is a perspective view showing the built-in skeleton structure of the vehicle seat of FIG. 1;

FIG. 4 is a planar cross-sectional view of the seat back skeleton along line A-A in FIG. 1;

FIG. 5 is a planar cross-sectional view of the seat back skeleton along line B-B in FIG. 1;

FIG. 6 is a perspective view showing a skeleton structure that is one comparative example pertaining to the vehicle seat of the present invention; and

FIG. 7 is a planar cross-sectional view of the main part of FIG. 6.

### DESCRIPTION OF EMBODIMENTS

The vehicle seat according to the present invention is described below on the basis of an embodiment. As shall be apparent, the present invention is not limited to this embodiment. In the drawings appended to the specification of the present invention, structural elements may be depicted in proportions that differ from those of the actual components, in order to show the characteristic portions in a readily understandable manner.

### Vehicle Seat

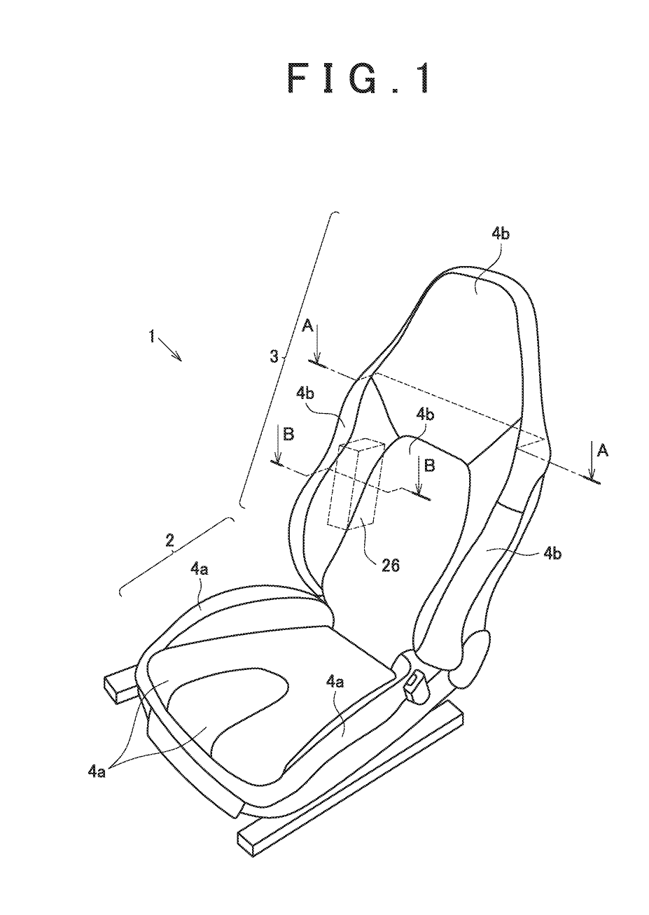

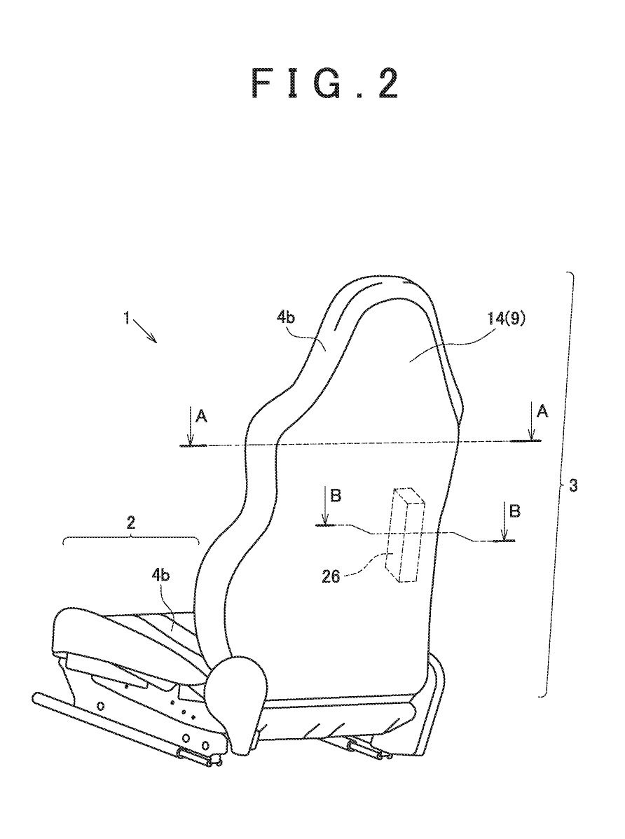

FIG. 1 shows an embodiment of a vehicle seat according to the present invention as seen from the front. FIG. 2 shows the vehicle seat as seen from the rear. This vehicle seat 1 has a seat cushion 2 upon which rest the buttocks of a seated passenger, and a seat back 3 for receiving the back of the seated passenger. The surface of the seat cushion 2 is covered by a surface skin 4a. The surface of the seat back 3 is covered by a surface skin 4b.

### Skeleton Structure

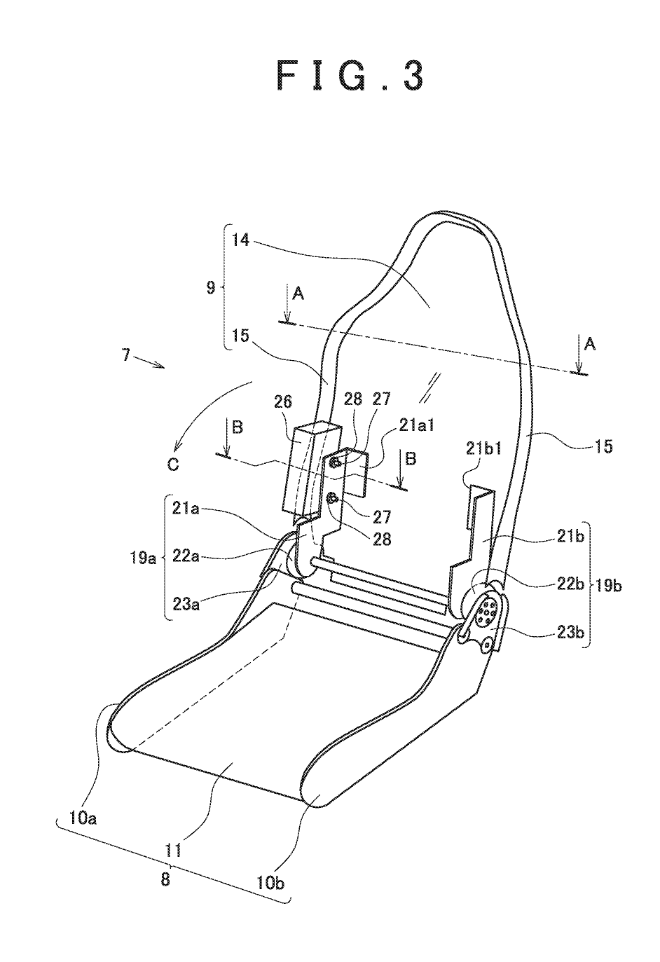

FIG. 3 shows a skeleton structure provided to the interior of the vehicle seat 1 of FIGS. 1 and 2. The skeleton structure 7 has a seat cushion skeleton 8 and a seat back skeleton 9. The seat cushion skeleton 8 is the skeleton structure of the seat cushion 2 of FIGS. 1 and 2. The seat back skeleton 9 of FIG. 3 is a frame constituting the skeleton structure of the seat back 3 of FIGS. 1 and 2.

The seat cushion skeleton 8 has a side frame 10a positioned on the right side of the seated passenger, a side frame 10b positioned on the left side of the seated passenger, and a center frame 11 provided between the side frames 10a, 10b. Various functional components in addition to the side frames 10a, 10b and the center frame 11 are included in the seat cushion skeleton 8 as necessary, but such functional components are not shown in FIG. 3. The side frames 10a, 10b and the center frame 11 are formed using a steel material or a hard synthetic resin.

The seat back skeleton 9 has a main body 14, which is a portion corresponding to the back and head of the seated passenger, and a peripheral wall part 15, which is an upright part provided to the peripheral edge of the main body 14. The main body 14 may be a single sheet member of uniform thickness that is un-curved and flat, or may be a single sheet member of uniform thickness that is gently curved so as to conform to a person's back. The peripheral wall part 15 is provided to the entire area of the peripheral edge of the main body 14. According to the above configuration, the seat back skeleton 9 of the present embodiment is not a frame-shaped member, but a shell-form seat back skeleton in which the portion corresponding to the back of the seat passenger is a sheet member.

The seat back skeleton 9 having the main body 14 and the peripheral wall part 15 is formed by a resin molding process using carbon fiber reinforced plastic (CFRP), which is a synthetic resin in which fibers are included. In CFRP, the carbon fibers can all be lined up together in one direction, or a plurality of layers including carbon fibers having different directions of extension can be layered resulting in structures in which the carbon fibers extend in different ways at random, the carbon fibers extend in random directions in a consecutively linked state, or other structures. CFRPs of any configuration can be used in the present embodiment. The seat back skeleton 9 can be formed of a synthetic resin other than CFRP.

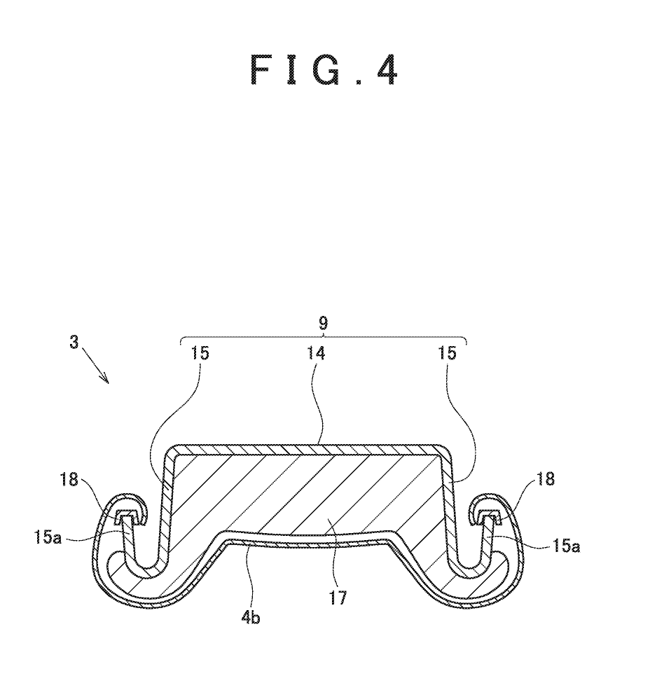

FIG. 4 shows the cross-sectional structure of a planar cross-sectional part of the seat back 3 along line A-A in FIG. 1. The cross-sectional portion of line A-A in FIG. 1 corresponds to the cross-sectional portion of line A-A in FIGS. 2 and 3. As shown in FIG. 4, a pad 17, which is an elastic member, is mounted on the front side of the seat back skeleton 9 of the seat back 3 (i.e., the side facing the seated passenger, the lower side in FIG. 4), and is formed by the surface of the pad 17 being covered by a surface skin 4b (see FIG. 1). The pad 17 is formed from, for example, a urethane foam that is an elastic member. The surface skin 4b is formed from, e.g., a textile, knit, or other type of fabric, natural leather or synthetic leather.

A folded-back part 15a is provided at the distal end of the peripheral wall part 15 of the seat back skeleton 9. A hook member 18 is secured to an end part of the surface skin 4b by being, e.g., sewn or bonded thereto. The hook member 18 is formed of a hard material such as a synthetic resin or a metal. The hook member 18 is hooked to the distal end of the end part 15a of the peripheral wall part 15 of the seat back skeleton 9, whereby the surface skin 4b is attached to the seat back skeleton 9, covering the pad 17.

The seat cushion 2 of FIG. 1, similar to the seat back 3, is also formed by mounting a pad on the periphery of the seat cushion skeleton 8 of FIG. 3, and covering the pad with the surface skin 4a of FIG. 1.

### Inclined Movement Structure of Seat Back

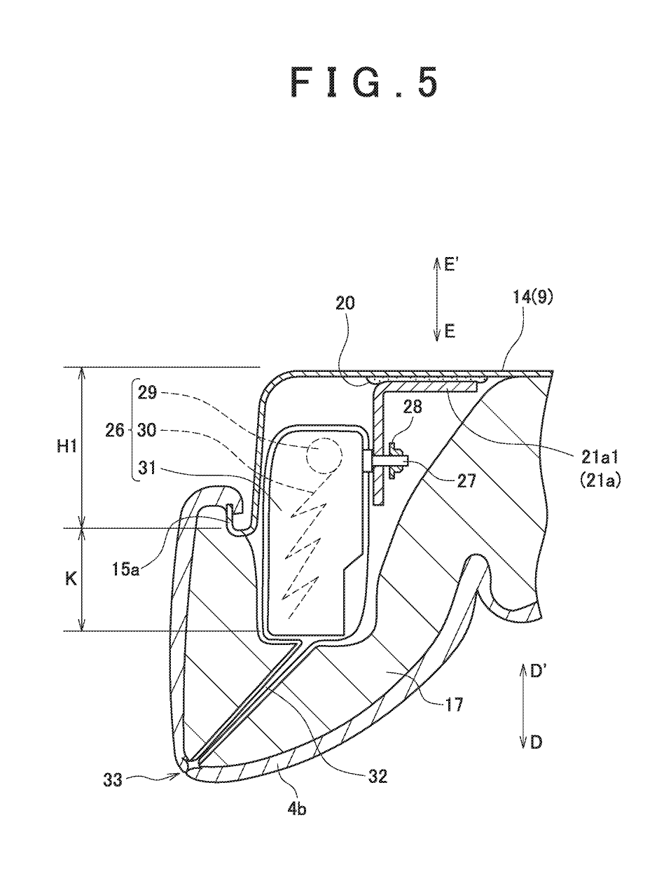

In FIG. 3, first brackets 21a, 21b are affixed to the inner surfaces of the left and right lower parts of the main body 14 of the seat back skeleton 9. Securing parts 21a1, 21b1 are provided to the brackets 21a, 21b. FIG. 5 is a cross-sectional view along line B-B in FIG. 1. The cross-section of line B-B of FIG. 1 corresponds to the cross-section of line B-B in FIG. 2 and FIG. 3. As shown in FIG. 5, the securing part 21a1 of the bracket 21a is affixed to the inner surface of the main body 14 of the seat back skeleton 9 by a bonding agent 20. The bonding agent 20 may be, for example, a synthetic rubber bonding agent or a thermosetting bonding agent. In FIG. 3, the securing part 21b1 of the bracket 21b is also likewise affixed to the inner surface of the main body 14 with a bonding agent.

In FIG. 3, one side surface of inclined movement mechanisms 22a, 22b is attached to the lower part of the brackets 21a, 21b. Second brackets 23a, 23b are attached to the other side surfaces of the inclined movement mechanisms 22a, 22b. In other words, the inclined movement mechanisms 22a, 22b are held sandwiched by the first brackets 21a, 21b and the second brackets 23a, 23b. Also, the second brackets 23a, 23b are joined to the end parts on the rear side of the side frames 10a, 10b of the seat cushion skeleton 8. The seat back skeleton 9 is thus coupled to the seat cushion skeleton 8. Thus, in the present embodiment, coupling means 19a, 19b for coupling the seat cushion skeleton 8 and the seat back skeleton 9 are configured by the first brackets 21a, 21b, the inclined movement mechanisms 22a, 22b, and the second brackets 23a, 23b.

The inclined movement mechanisms 22a, 22b have a function in which a spring (e.g., a coiled spring), which is an elastic member, urges the seat back skeleton 9 so as to rotate forward (i.e., inclined movement) as shown by arrow C. Also, the inclined movement mechanisms 22a, 22b can be placed in an unlocked state so as to make it possible for the seat back skeleton 9 to move at an incline with respect to the seat cushion skeleton 8. The specific structure of the inclined movement mechanisms 22a, 22b can be constructed using, for example, a structure known as a reclining mechanism from the prior art.

When the inclined movement mechanisms 22a, 22b are positioned in the unlocked state, the seat back skeleton 9 moves in an inclined manner in the forward direction, as shown by arrow C, due to the action of the elastic urging function of the inclined movement mechanisms 22a, 22b. The seat back 3 can thereby be moved in an inclined manner in a direction toward the seat cushion 2 (i.e., the forward direction) in FIG. 1. The range of inclined movement is restricted by the inclined movement mechanisms 22a, 22b. If the locked position is within the range of inclined movement, switching the inclined movement mechanisms 22a, 22b to the locked state will allow the seat back to be secured (i.e., locked) in a position appropriate for the seated passenger.

Thereafter, if the inclined movement mechanisms 22a, 22b are again positioned in the unlocked state, and if the seat back 3 of FIG. 1 is then raised upward as shown, and if the inclined movement mechanisms 22a, 22b of FIG. 3 are then again positioned in the locked state, the seat back 3 can be secured in a raised state such as that shown in FIG. 1.

In the present embodiment, as described above, since the seat back skeleton 9 of FIG. 3 is formed by resin molding using CFRPs, the seat back skeleton 9 can be formed into a light, high-strength shape that is a shell shape (i.e., a panel shape), which is a thin sheet shape with a high peripheral wall part. Such a shell-form seat back skeleton is advantageously used in a bucket seat (i.e., a seat in which the left and right edges are made high and the rear and shoulders of the seated passenger settle deeply into the seat, whereby the seated passenger is made more secure).

### Air Bag Device

In FIG. 1 and FIG. 2, an air bag device 26 is provided to a predetermined position inside the seat back 3. The air bag device 26 is provided in the space formed between the peripheral wall part 15 of the seat back skeleton 9 and the first bracket 21a, as shown in FIG. 3 and FIG. 5. A threaded rod 27 extending from the air bag device 26 is fastened by a nut 28, whereby the air bag device 26 is secured to the first bracket 21a. The air bag device 26 is thereby supported by the first bracket 21a.

In FIG. 5, the air bag device 26 has a detonator 29, an air bag 30, and a casing 31 in which the detonator 29 and air bag 30 are stored. When the vehicle is subjected to impact by colliding with another object, the detonator 29 detonates in response to the force of the impact and the air bag 30 pushes open the door of the casing 31 and expands outward. The expanded air bag 30 passes through a pathway 32 formed within the pad 17, ruptures a sewn seam 33 in the surface skin 4b and expands outward to deploy, protecting the seated passenger.

In the present embodiment, the first bracket 21a is affixed to the main body 14 of the seat skeleton 9 by a bonding agent 20 (i.e., to the wide-area portion corresponding to the back of the passenger); therefore, a space can be formed between the peripheral wall part 15 of the seat back skeleton 9 and the first bracket 21a, and the air bag device 26 can be installed in the space. Since the air bag device 26 is secured to the first bracket 21a, and not joined to the peripheral wall part 15 of the seat back skeleton 9, the shape of the peripheral wall part 15 can be set freely.

For example, a height H1 of the peripheral wall part 15 can be set lower. As a result, a gap K from the distal end of the air bag device 26 to the distal end of the peripheral wall part 15 can be set larger. Doing so will keep the peripheral wall part 15 from obstructing the opening of the door of the casing 31 when the air bag 30 deploys, improving the deployment performance of the air bag device 26.

With regard to the present embodiment, furthermore, since in FIG. 3 the first brackets 21a, 21b are not affixed to the peripheral wall part 15 of the seat back skeleton 9, but to the main body 14, which has a large surface area and extends in a direction perpendicular to the longitudinal front-rear direction of the vehicle (the direction indicated by the double-headed arrow D-D′ in FIG. 5), a force such as will push against a surface acts, as shown by the double-headed arrow E-E′ in FIG. 5, upon the surfaces at which the first brackets 21a, 21b are affixed to the main body 14 when the vehicle is involved in a rear-end or head-on collision. As a result, the seat back skeleton 9 can be prevented from warping when the vehicle is involved in a rear-end or head-on collision.

With regard to the present embodiment, furthermore, since the first brackets 21a, 21b are affixed to the main body 14 of the seat back skeleton 9 by bonding in FIG. 3, there is no need for forming holes in the main body 14 as when the brackets are affixed with bolts. If a hole or another portion of different shape were to be provided to the seat back skeleton 9, stress might accumulate at this differently shaped portion and the seat back skeleton 9 may fracture starting from the differently shaped portion. By contrast, in a case where the first brackets 21a, 21b are affixed to the main body 14 of the seat back skeleton 9 by bonding, as in the present embodiment, there is no need for forming a differently shaped portion such as a bolt hole in the seat back skeleton 9, and damage to the seat back skeleton 9 can accordingly be prevented.

The likelihood of damage is particularly high when a differently shaped portion is formed in the seat back skeleton 9 in a case where the seat back skeleton 9 is formed of CFRP, which is a fiber-reinforced material. Accordingly, an affixing process using bonding such as in the present embodiment is particularly beneficial when the seat back skeleton 9 is formed of CFRP.

### Comparative Example

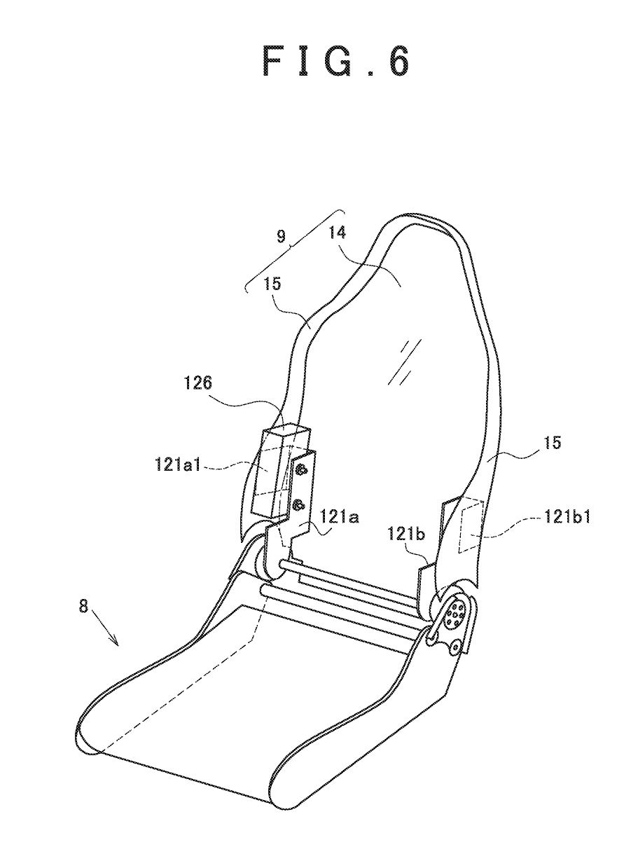

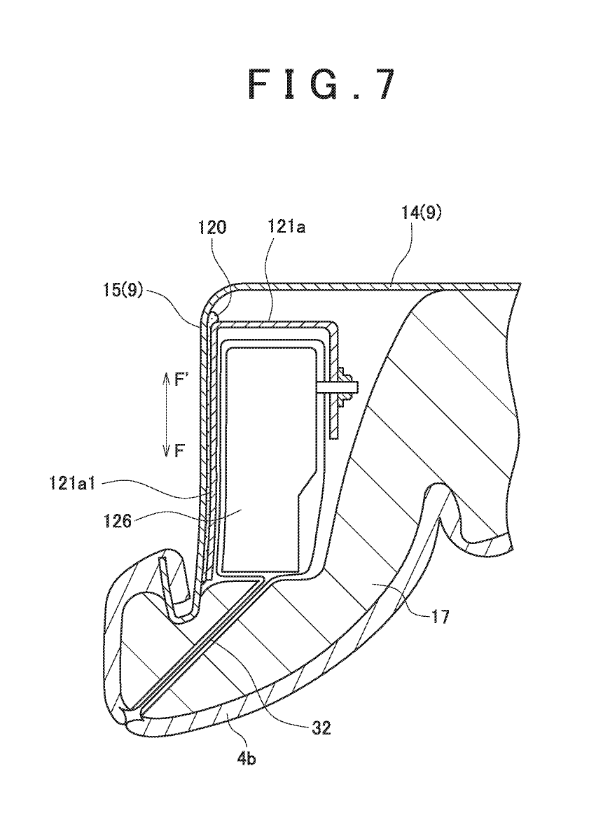

FIG. 6 and FIG. 7 show a comparative example for the vehicle seat of the present invention. FIG. 6 is a view corresponding to FIG. 3 of the present embodiment, and FIG. 7 is a view corresponding to FIG. 5 of the present embodiment. In the embodiment shown in FIG. 5, the first bracket 21a is affixed to the main body 14 of the seat back skeleton 9 by bonding, as shown in FIG. 5. In contrast, in the present comparative example, a securing part 121a1 of a first bracket 121a is affixed to the peripheral wall part 15, which is a side surface of the seat back skeleton 9, by a bonding agent 120, as shown in FIG. 7. In FIG. 3, a securing part 121b1 of a first bracket 121b on the opposite side is also affixed to the peripheral wall part 15 in a similar manner.

When the first brackets 121a, 121b are so affixed to the peripheral wall part 15, the peripheral wall part 15 must be adequately increased in height in order to ensure sufficient bonding force. However, doing so inevitably narrows the deployment path of an air bag device 126, which may adversely affect the deployment performance of the air bag device 126.

When the vehicle is involved in a rear-end or head-on collision, a force will act upon the bonding surface in the direction shown by the double-headed arrow F-F′, and the seat back skeleton 9 may warp as a result.

### Other Embodiments

The present invention has been described with reference to the preferred embodiment above. However, the present invention is not limited to this embodiment; various modifications are possible within the scope of the invention set forth in the claims.

In the above-described embodiment, coupling means 19a, 19b for coupling the seat cushion skeleton 8 and the seat back skeleton 9 are configured by the combination of the first brackets 21a, 21b, the inclined movement mechanisms 22a, 22b, and the second brackets 23a, 23b, as shown in FIG. 3. However, the coupling means 19a, 19b can have a structure other than the above. For example, the inclined movement mechanisms 22a, 22b can be any mechanism other than a reclining mechanism.

The material of the seat back skeleton 9 can be a suitable synthetic resin other than CFRP.

### REFERENCE SIGNS LIST

1. Vehicle seat, 2. Seat cushion, 3. Seat back, 4a, 4b. Surface skin, 7. Skeleton structure. 8. Seat cushion skeleton, 9. Seat back skeleton, 10a, 10b. Side frame, 14. Main body, 15. Peripheral wall part, 15a. Folded-back part, 17. Pad, 18. Hook member, 19a, 19b. Coupling means, 20. Bonding agent, 21a, 21b. First brackets, 21a1, 21b1. Securing parts, 22a, 22b. Inclined movement mechanisms, 23a, 23b. Second brackets, 26. Air bag device, 27. Threaded rod, 28. Nut, 29. Detonator, 30. Air bag, 31. Casing, 32. Pathway, 33. Sewn seam, 120. Bonding agent, 121a, 121b. First brackets, 121a1, 121b1. Securing parts, 126. Air bag device,

1. A vehicle seat comprising a seat cushion upon which the buttocks of a seated passenger rest, and a seat back for receiving the back of the seated passenger;
the seat cushion comprising a seat cushion skeleton, a pad mounted on the seat cushion skeleton, and a surface skin covering the pad;
the seat back comprising a seat back skeleton, a pad mounted on the seat back skeleton, and a surface skin covering the pad;
the seat cushion skeleton and the seat back skeleton being coupled by coupling means;
the seat back skeleton comprising a main body facing the back of the seated passenger, and a peripheral wall part provided to the peripheral edge of the main body, and the main body and the peripheral wall part being formed into an integrated shell shape by a synthetic resin;
the coupling means comprising a first bracket joined to the seat back skeleton; and
the first bracket being affixed by bonding to the main body of the seat back skeleton.

2. The vehicle seat of claim 1, wherein:
the coupling means comprises
an inclined movement mechanism for supporting the seat back skeleton so as to be able to move at an incline with respect to the seat cushion skeleton, and
a second bracket that work in cooperation with the first brackets to hold the inclined movement mechanism therebetween; and
the second bracket is connected to the seat cushion skeleton and thereby coupling the seat cushion skeleton and the seat back skeleton together.

3. The vehicle seat of claim 2, wherein the first bracket comprises a portion for forming a gap with respect to the peripheral wall part of the seat back skeleton; and an air bag device is stored in the gap.

4. The vehicle seat of claim 3, wherein the seat back skeleton is formed from carbon fiber reinforced plastic.

5. The vehicle seat of claim 1, wherein the first bracket comprises a portion for forming a gap with respect to the peripheral wall part of the seat back skeleton; and an air bag device is stored in the gap.

6. The vehicle seat of claim 1, wherein the seat back skeleton is formed from carbon fiber reinforced plastic.
